(19) United States
(12) Patent Application Publication
(10) Pub. No.: US 2016/0115921 A1
(43) Pub. Date: Apr. 28, 2016

(54) INJECTOR WAVEFORM

(71) Applicant: INTERNATIONAL ENGINE INTELLECTUAL PROPERTY COMPANY , LLC, Lisle, IL (US)

(72) Inventor: Alain Vande Walle, Naperville, IL (US)

(73) Assignee: International Engine Intellectual Property Company , LLC, Lisle, IL (US)

(21) Appl. No.: 14/893,358

(22) PCT Filed: May 24, 2013
(86) PCT No.: PCT/US13/42749

§ 371 Date: Nov. 23, 2015

(51) Int. Cl. F02M 51/06

(52) U.S. Cl. CPC F02M 51/0614

(57) ABSTRACT

A system for controlling the displacement of a spool in a spool valve of a fuel injector. One or more coils may be employed to move the spool between closed and open positions in the fuel injector. The shape of the current waveform used to generate a magnetic field in one or more coils for displacing the spool may vary depending on engine operating conditions. Moreover, the shape of the current waveform applied to coils in the fuel injector may be different for engine operating conditions. Such differences in waveform shape may at least assist, in real time, with the engine obtaining improved engine emissions and/or otherwise obtaining fuel injection goals.

### BACKGROUND

Illustrated embodiments relate to the use of electrical current waveforms to control the operation of a spool valve of a fuel injector. More specifically, illustrated embodiments relate the selection and use of multiple current waveforms for a dual coil of a fuel injector to control the operation of a spool valve based on the operating conditions of the associated engine.

In an attempt to comply with increasingly stringent emissions control standards for internal combustion engines, fuel injectors often seek to inject fuel into the combustion chamber of an engine at elevated or amplified pressures. By increasing the pressure of the fuel that is injected into the combustion chamber, both the atomization of the fuel and the mixing of the fuel with oxygen present in the cylinder may improve. As a result, the ability to achieve complete combustion of the fuel may be improved, which may thereby reduce the quantity of particulates formed during the combustion event.

To attain increases in fuel injection pressure, fuel injectors may include an intensifier piston that, when displaced, compresses fuel within the fuel injector so as to elevate the pressure of the fuel. The displacement of the piston may be attained through the use of an actuating fluid, such as pressurized oil, that presses on the piston so as to displace the intensifier piston. The application of the actuating fluid on the piston may be controlled by a spool valve. Moreover, a spool of the spool valve may be moved from a closed position, where the spool covers or closes an opening to a passageway that directs the flow of actuating fluid to the intensifier piston, to an open position, where the spool no longer covers the opening so that actuating fluid may flow through the passageway and at least assist in providing the force necessary for the displacement of the piston.

Attempts to attain higher fuel injection pressures may include increasing the pressure and quantity of actuating fluid that acts on the intensifier piston. However, such pressure and quantity increases of the actuating fluid may require increasing the size of certain components within the fuel injector. For example, the passageway, including its opening, which leads the actuating fluid to the intensifier piston, may need to be increased. However, such increases in the size of the passageway typically require the spool to travel a greater distance before the spool either fully opens or closes the passageway. Further, in order to ensure that the spool sufficiently covers the increased size of the opening of the passageway when the spool is in a closed position, the size of the spool may need to be increased and/or the shape of the spool may need to be changed. But these changes may adversely impact the time necessary for the spool to move from the closed position to the open position, and vice versa. Further, such delays in the spool's response times may adversely impact the fuel injector's ability to inject small amounts of fuel at desired fuel injection pressures, increases the variability of fuel injection pressure between different fuel injection events, and may be detrimental to the vehicle idle quality and cold start capability. Additionally, the increased pressure of the actuating fluid may cause the actuating fluid to push a spool that is intended to remain, at least for the moment, in an open position toward the closed position.

### BRIEF SUMMARY

An aspect of an illustrated embodiment is a method for controlling the movement of a spool of a spool valve. The method includes determining a first engine operating condition and selecting, by a control unit, based on the first engine operating condition, a first open current waveform. The first open current waveform is applied to at least a first coil to displace the spool from a closed position to an open position. Further, a first closed current waveform is applied to at least a second coil to displace the spool from the open position to the closed position. The method also includes determining a second engine operating condition. The control unit selects, based on the second engine operating condition, a second open current waveform. The second open current waveform has a waveform shape that is different than a waveform shape of the first open current waveform. Additionally, the second open current waveform is applied to at least the first coil to displace the spool from the closed position to the open position.

Another aspect of an illustrated embodiment is a method for controlling the displacement of a spool of a spool valve in a fuel injector having a first coil and a second coil. The method includes selecting, by the control unit, from a plurality of different current waveform shapes, a first current waveform for a first engine operating condition. The first current waveform is applied to the first coil to displace the spool from a first position to a second position. The method also includes returning the displaced spool from the second position to the first position. The control unit also selects from the plurality of different current waveform shapes a second current waveform for a second engine operating condition. The second current waveform has a waveform shape that is different than a waveform shape of the first current waveform. Additionally, the second current waveform is applied to the first coil to displace the spool from a first position to a second position.

A further aspect of an illustrated embodiment is a method for controlling the displacement of a spool of a spool valve in a fuel injector. The method includes assigning a current waveform to each of a plurality of groups of engine operating conditions. At least a plurality of the assigned current waveforms each have a waveform shape that is different than the waveform shape of other assigned current waveforms. The method also includes detecting a first engine operating condition that is part of a first group of the plurality of groups of engine operating conditions. The current waveform assigned to the first group of engine operating conditions is applied to at least one coil. Additionally, the magnetic field generated by applying the current waveform to the at least one coil is used to displace the spool of the spool valve.

### BRIEF DESCRIPTION OF SEVERAL VIEWS OF THE DRAWINGS

FIG. 1A illustrates an exemplary block diagram of an actuating fluid system.

FIG. 1B illustrates a cross-sectional view of a representative hydraulically actuated, electronically controlled fuel injector.

FIG. 2 illustrates an exemplary annotated engine operation map indicating implementation of different current waveforms across the coils of a fuel injector control valve during different engine operating conditions.

FIG. 3 illustrates an anti-rebound waveform that may be applied to the coils of the fuel injector control valve during particular engine operating conditions.

FIG. 4 illustrates a baseline waveform that may be applied to the coils of the fuel injector control valve during particular engine operating conditions.

FIG. 5 illustrates a power waveform that may be applied to the coils of the fuel injector control valve during particular engine operating conditions.

FIG. 6 illustrates a maintain waveform that may be applied to the coils of the fuel injector control valve during particular engine operating conditions.

FIGS. 7A and 7B illustrate sharp-Edge waveforms that may be applied to the coils of the fuel injector control valve during particular engine operating conditions.

### DETAILED DESCRIPTION

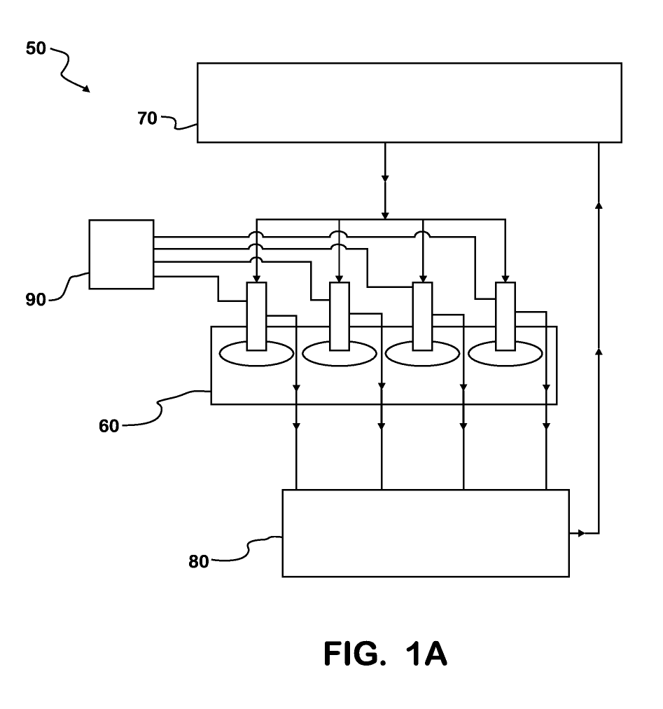

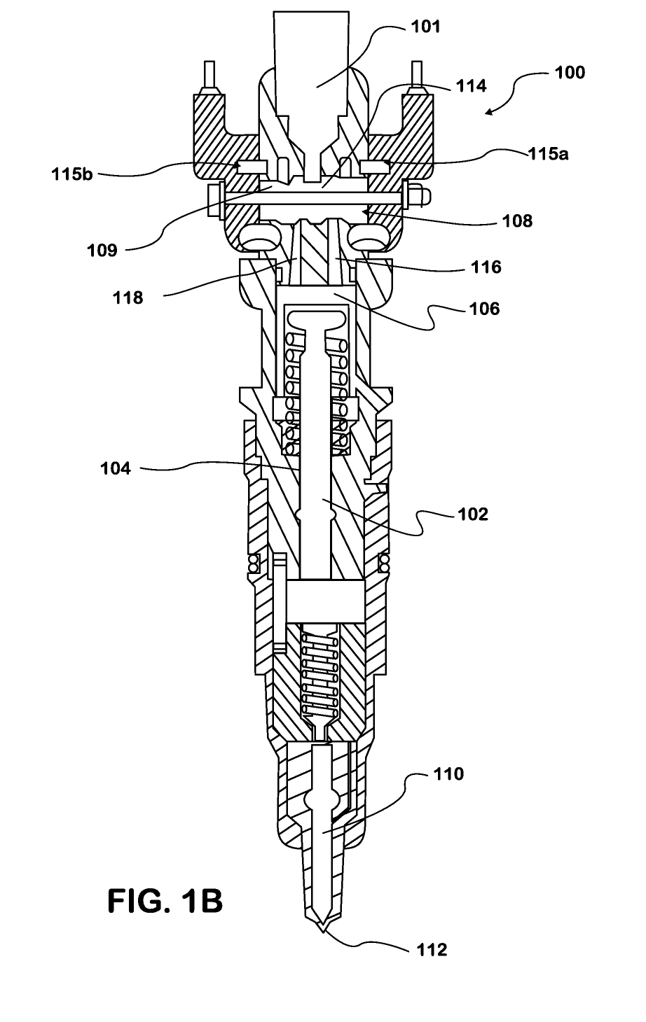

Referencing FIGS. 1A and 1B, a fuel injector 100 may be used with an electronically controlled fuel injection system. In the fuel system, an actuating fluid system 50 may supply an actuating fluid, such as oil, at high pressure through a hose, tube, or common rail to each of a series of unit fuel injectors 100 within an engine cylinder head 60. Prior to delivery, the pressure of the actuating fluid may be increased by a high-pressure fluid pump and/or a hydraulic amplification system 70. This high-pressure fluid pump 70 may be driven by a variety of sources, such as, for example being an engine power-take off component or driven electrically. According to certain embodiments, the high-pressure fluid pump 70 may be used to elevate the pressure of the actuating fluid to approximately 3000 psi and higher. However, the pressures obtained by the actuating fluid system 50 may be dependent on the type and/or size of the pump 70 used by the system 50. Actuating fluid may be received in the fuel injector 100 through a fluid inlet 101.

The fuel injector 100 includes an electronically controlled control valve 108 that is used to control the delivery of the high pressure actuating fluid in the fuel injector 100 to an intensifier piston 106. A volume of actuating fluid, such as a control volume, may be delivered to a location in the fuel injector 100 that is adjacent to an upper surface of the intensifier piston 106. The control volume of actuating fluid may exert a force on the intensifier piston 106 to displace the intensifier piston 106 and associated plunger 102 into an area of the fuel injector 100 that was previously occupied by fuel while increasing the pressure of fuel in the fuel injector 100.

The supply of actuating fluid for the control volume may be controlled by the control valve 108. The control valve 108 may be a spool valve 111 that includes at least one spool 109 and at least one coil 115. In the illustrated embodiments, a pair of coils 115a, 115b may be used to control the position of the spool 109 within a chamber 114 in the fuel injector 100. The chamber 114 may be in fluid communication with the fluid inlet 101 and be configured for reciprocal movement of the spool 109 within the chamber 114. Additionally, the chamber 114 may be in communication with an inlet passageway 116 that is configured for the delivery of actuating fluid to the area adjacent to the intensifier piston 106 so as to be used as the control volume of actuating fluid. Additionally, according to certain embodiments, the chamber 114 may also be fluid communication with an outlet passageway 118 that is used to evacuate actuating fluid that had been used as a control volume of actuating fluid back into the chamber 114 and subsequently out of the fuel injector 100. Additionally, depending on the injector 100 design, rather than being separate pathways, the inlet and outlet pathways 116, 118 may be the same pathway. At least a portion of the actuating fluid evacuated from the fuel injectors 100 may be subsequently collected in a sump 80 and re-circulated in the system 50.

The position of the spool 109 within the chamber 114 may determine whether actuating fluid may flow into the inlet passageway 116 and/or out of the outlet passageway 118. Moreover, when in the closed position, the spool 109 may cover or otherwise prevent the flow of actuating fluid into the inlet passageway 116. Further, when in an open position, the spool 109 may be positioned to allow actuating fluid to enter into the inlet passageway 116 so that a sufficient quantity and/or pressure of actuating fluid may provide a force to displace the intensifier piston 106.

The position of the spool 109 may be controlled by the supply, or lack thereof, or electrical current to one or more of the coils 115a, 115b. The flow of electrical current through the metallic coils 115a, 115b may create a magnetic field that is used to attract and/or repel the spool toward or from a coil 115a, 115b. For example, for purposes of illustration, referencing FIG. 1B, an electrical current through a first coil 115a, and not a second coil 115b, may attract and/or displace the spool 109 toward the first coil 115a. The spool 109 may then be displaced toward the second coil 115b when an electrical current flows through the second coil 115b, and not the first coil 115a. Such displacement may be used to control the position of the spool 109 within the chamber 109. Moreover, such displacement may be used to control whether the spool 109 is in an open or closed position so as to control the flow of actuating fluid for purposes of displacing the intensifier piston 106 and amplifying injection fuel pressure.

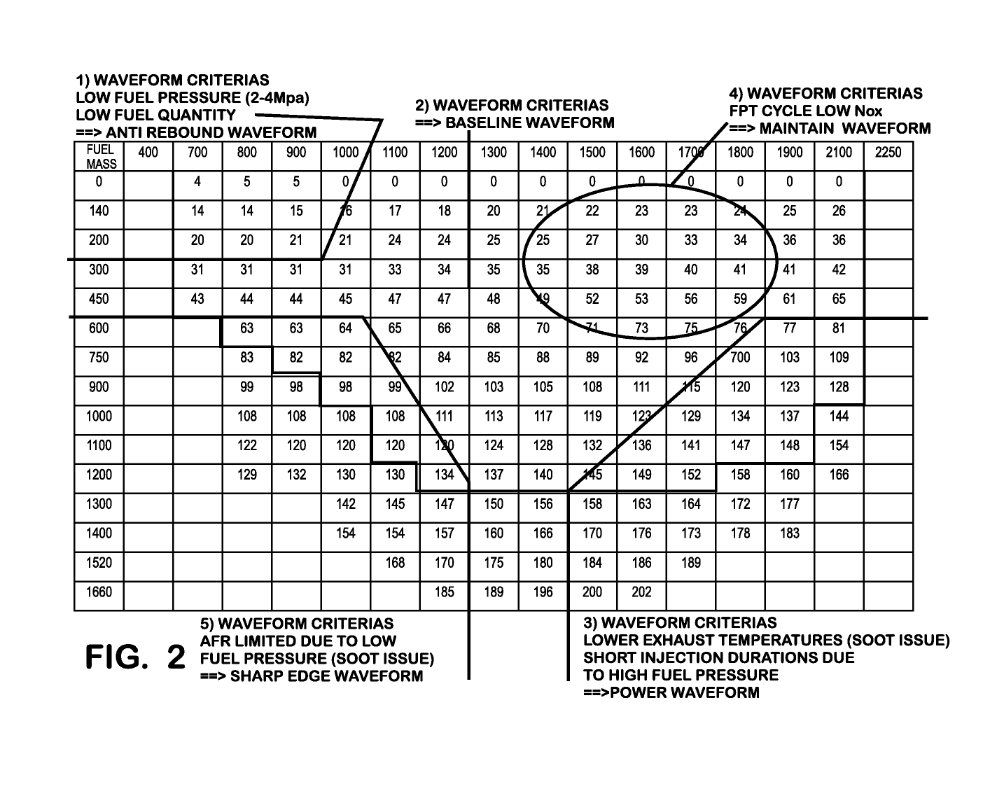

According to certain embodiments, a control unit 90, such as an electronic control unit or an injector drive module, may control the application of the electric current being delivered across the coils 115a, 115b. The size and/or duration of the current applied to the coils 115a, 115b that is used in displacing the spool 109 between open and closed positions may depend on the operating conditions of the engine. Moreover, the characteristics of the electrical current waveform applied to the coils 115a, 115b used to change the position of the spool 109 may be driven by different, real-time characteristics of the engine's operation, including, for example, rail pressure, fuel pressure, operation modes, measurements during engine operation, and/or associated data provided by an operational map. For example, FIG. 2 illustrates an annotated engine operation map that indicates the fuel mass (mg/stroke) of the fuel needed, or will be, to injected by the fuel injector 100 into the combustion chamber when the engine is operating at a particular torque (vertical axis) and revolutions per minute (RPMs) (horizontal axis). For example, the operational map shown in FIG. 2 indicates that for 700 RPMs and 140 ft-lb, the fuel injector will be injecting 14 mg of fuel into the combustion chamber per engine stroke (mg/stk). The operational map may however contain a variety of other, different types of operational data.

The data provided on the operational map of FIG. 2, or through the use of other engine operational data, may be used to implement, in real time, electronic driver and control strategies that provide different electronic waveforms for use with the coils 115a, 115b that address prior issues with using larger sized spools 109. For example, as previously discussed, as the size and/or shape of the spool 109 is increased to accommodate the higher pressure of the actuating fluid, the response time of the spool 109 may decrease. However, testing may indicate that the use of a particular type of waveform for the current applied to the coils 115a, 115 during particular engine operating conditions may lead to improve spool 109 movement and/or response times that achieve different engine emission and/or fuel injection goals. For example, movement of the spool 109 using a particular electronic waveform across a coil 115a, 115b during particular engine operating conditions may assist in obtain hydrocarbon and soot generation limitations that are not achieved using that same waveform during other, different, engine operating conditions.

The type of waveform current applied to one or more of the coils 115a, 115b employed during particular engine operating conditions may be determined through the use of testing. Variations of the engine waveform may include abrupt switching between waveforms. Alternatively switching between waveforms may be implemented smoothly, such as by interpolation between two different waveforms using different waveform parameters such as, for example, peak time and current, hold time and current, and reverse time and current, among others.

The operational map shown in FIG. 2 illustrates an example of using five different types of current waveforms that may be applied to the coils 115a, 115b during different engine operating conditions. For example, the operational map indicates that a first waveform may be employed when the engine torque is between 0 and 200 ft-lb and the engine RPMs extend from approximately 900 to approximately 1100 RPMs. According to this illustrated embodiment, when the engine operating conditions are within the prescribed region of the first waveform, the control unit 90 may provide instructions or otherwise control the application of electrical current to the coils 115a, 115b such that shape of the current waveform resembles an anti-rebound waveform.

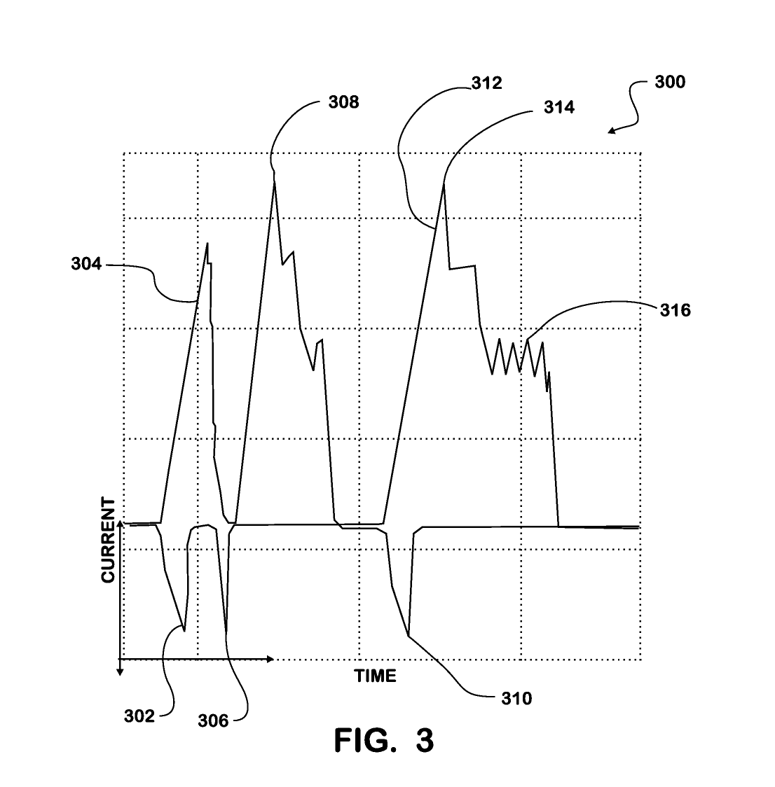

An example of an anti-rebound waveform 300 is provided in FIG. 3. The lateral axis illustrates time, while the horizontal axis depicts electrical current. Further, the left portion of FIG. 3 illustrates the application of current to the coils 115a, 115b of the spool 109 from a closed position (where the spool 109 is in relative close proximity to the second coil 115b) to an open position (where the spool 109 is in relative close proximity to the first coil 115a), while the right portion of FIG. 3 illustrates the spool returning from the open position to the closed position. As shown, when in the closed position, the control unit 90 may control the application of a first counter current 302 to the second coil 115b while the control unit 90 also controls the application of a first displacement current 304 to the first coil 115a. According to certain embodiments, the first counter current 302 may be used to hold the position of the spool 109 until the first displacement current 304 is predicated to have been provided with a sufficient current to magnetically saturate the first coil 115a. Application of the first counter current 302 may then be terminated, around which time the spool 109 may be displaced toward the open position. Further, the size of the first displacement current 304 may be reduced as the spool 109 approaches the open position. Further, before the spool 109 reaches the open position, in an attempt to prevent the spool 109 from hitting a sidewall of the chamber 114, a brake current 306 may be applied to the second coil 115b which is used to slow the movement of the spool 109, and thereby reduce or prevent the impact of the spool 109 with the sidewall of the chamber 114 that may otherwise cause the spool 109 to rebound in a direction generally back towards the closed position. Once the brake current 306 is terminated by the control unit 90, the control unit 90 may instruct that the first coil 115a receive a maintain current 308, which may be used to maintain the spool 109 in the open position. As show, after obtaining a peak in current, the maintain current 308 may be decreased over time.

When the spool 109 subjected to the anti-rebound waveform 300 is to be returned to a closed position, the control unit 90 may control the application of a second counter current 310 to the first coil 115a, while the control unit 90 also controls the application of a second displacement current 312 to the second coil 115b. The second counter current 310 may be used to hold the position of the spool 109 in the open position until the second displacement current 312 is predicated to have been provided with a sufficient current to magnetically saturate the second coil 115b. Application of the second counter current 310 may then be terminated, around which time the spool 109 may be displaced toward the closed position. Further, the size of the second displacement current 312 may be reduced from the peak current 314 that was used to at least initially displace the spool 109 to a hold current 316 that is sufficient to continue the movement of the spool 109 at the desired speed to the closed position.

The second waveform identified in the exemplary operational map in FIG. 2 is the baseline waveform. As indicated, the baseline waveform may be applied as a standard or default waveform. Moreover, the baseline waveform may be employed when engine operating conditions necessary for the application of other current waveforms are not satisfied.

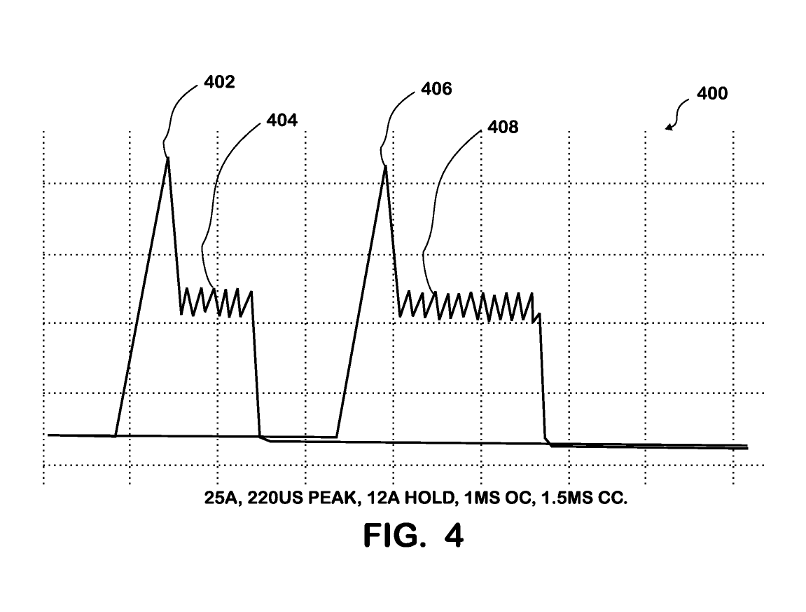

FIG. 4 provides an example of a baseline waveform 400. As shown, according to certain embodiments, the control unit 90 may control the application of a 25 amp first peak current 402 that may be applied to the first coil 115a for 220 μsec to at least initiate the displacement of the spool 109 from the closed to the open position. After the spool 109 begins being displaced, the control unit 90 may control the application of a first hold current 404 of 12 amps to the first coil 115a so as to continue the movement of the spool 109 towards the open position. The first peak and hold currents 402, 404 may be applied for a total open current time of 1 millisecond. When the spool 109 is to be returned to the closed position, a 25 amp second peak current 406 may be applied to the second coil 115b for 220 μsec to at least initiate the displacement of the spool 109 from the open position to the closed position. After the spool 109 begins being displaced toward the closed position, a second hold current 408 of 12 amps may be applied to the second coil 115b so as to continue the movement of the spool 109 towards the closed position. The second peak and hold currents 406, 408 may be applied for a total close current time of 1.5 milliseconds. Differences in the close and open current times may be attributed, among other things, (1) extending the close current time to ensure that the spool 109 reaches and is in the closed position when the spool 109 is displaced from the open position, and/or (2) terminating the open current in sufficient time when the spool 109 is being moved to an open position so as to prevent, or minimize the impact of, the spool 109 hitting a sidewall of the chamber 114.

A third waveform that may be implemented by the control unit 90 based on engine operating conditions is a power waveform. The power waveform may be employed by the control unit 90 when it is predicted that lower combustion temperatures are being obtained, which may result in an undesirable increase in soot generation. The power waveform may also be employed when shorter periods of fuel injection into the combustion chamber is/are being experienced due to relatively high fuel injection pressures.

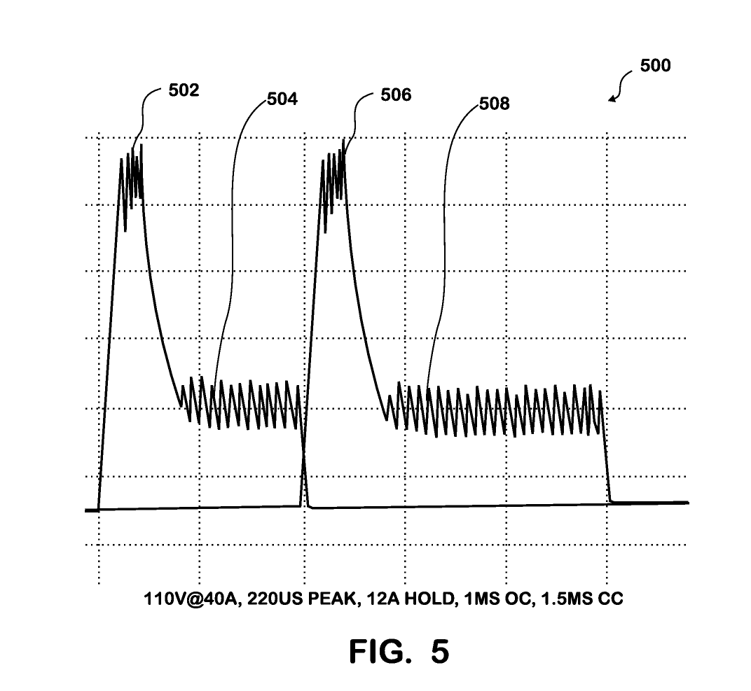

FIG. 5 illustrates an example power waveform 500 that may be employed by the control unit 90. The illustrated power waveform 500 is similar to the baseline waveform 400 with the exception that the power waveform 500 has larger first and second peak currents 502, 506 (approximately 40 amps) than the first and second peak currents 402, 406 (approximately 25 amps) of the baseline waveform. Such larger first and second peak currents 502, 506 initially provide more energy to the associated coils 115a, 115b so that the coils 115a, 115b become magnetically saturated faster, and which may increase the speed at which the spool 109 is at least initially launched toward the open or closed positions, respectively. As shown, according to certain embodiments, the first and second hold currents 504, 508 used to continue the displacement toward the open and closed positions, respectively, may be the same as the first and second hold currents 404, 408 of the baseline waveform, such as, in the illustrated embodiments, 12 amps. And similar to baseline waveform, in the illustrated embodiment, the time current is applied to displace the spool 109 to the open position (1 millisecond) and the time current is applied to displace the spool 109 to the closed position (1.5 millisecond) may be the same as that used by the baseline waveform.

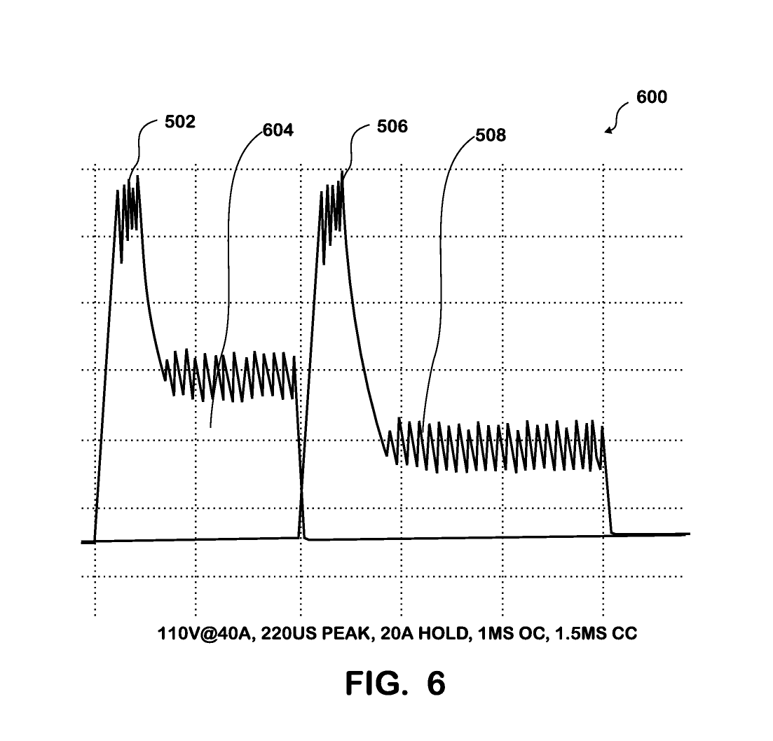

The fourth waveform identified in the exemplary operational map in FIG. 2 and shown in FIG. 6 is the maintain waveform. In the illustrated embodiment, application of the third current waveform to the coils 115a, 115b by the control unit 90 may occur when engine operating conditions allows for the fuel mass (mg/stk) to fall in operating parameters associated with the circled region shown in FIG. 2. Moreover, according to certain embodiments, the maintain waveform may be employed when the engine is predicted to be operating at conditions that allow for lower NOₓ conditions.

Referencing FIG. 6, the maintain waveform 600 is similar to the power waveform 500 with the exception that the first hold current 604 is higher than the first hold current 504 of the power waveform 500 so that the spool 109 has a higher velocity when moving to the open position when the first hold current 604 is applied to the first coil 115a. This increased velocity may increase the potential for and/or the distance that the spool rebounds off of a sidewall of the chamber 114 as the spool reaches the open position. However, the higher current of the first hold current 604 may assist in pulling back, and maintaining, the rebounded spool 109 in the open position.

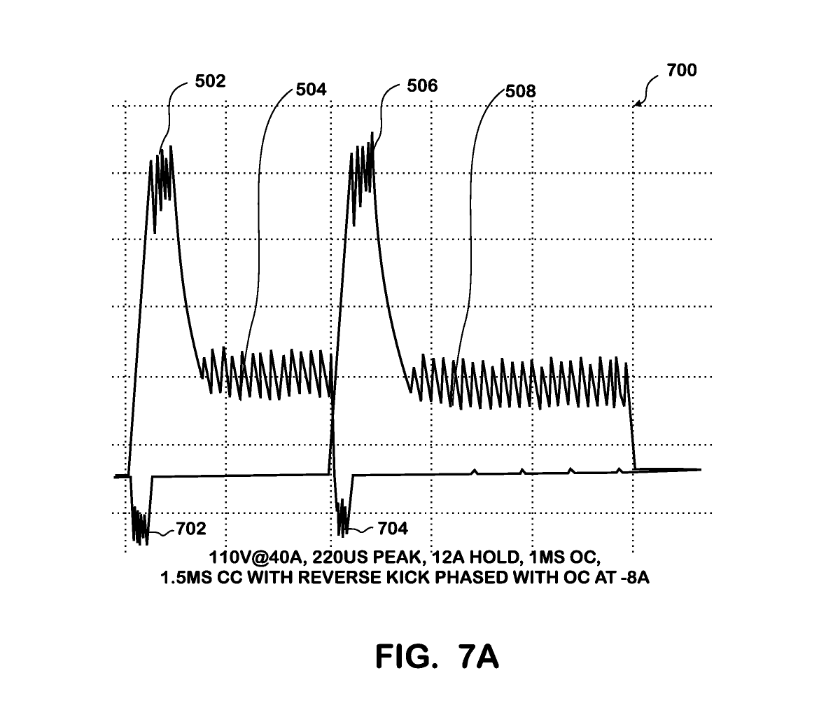

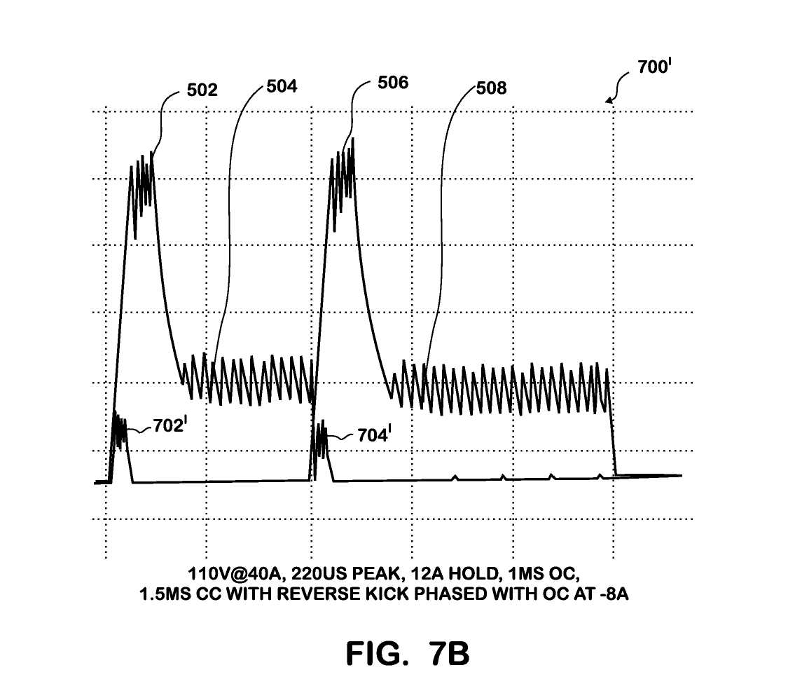

The fifth waveform identified by the operational map in FIG. 2 is the sharp-edge waveform 700. The sharp-edge waveform 700 may be used where engine conditions are predicted to currently involve low air-to-fuel ratios that may cause an increase in soot formation from the combustion process. Thus, the control unit 90 may employ a sharp-edge waveform 700 to the coils 115a, 115b that controls the movement of the spool 109 in a manner that may assist in minimizing the formation of such undesirable soot. FIGS. 7A and 7B illustrate two examples of sharp-edge waveforms. As shown, the sharp-edge waveform 700 may have waveforms that are similar to the power waveform 500 illustrated in FIG. 5. However, the sharp-edge waveform 700 may also apply current to one coil, such as the second coil 115b, that is used to hold the position of the spool 109 while the magnetic field of the other coil, such as the first coil 115a, is being saturated. Such holding of the position of the spool 109 until the magnetic field of a coil 115a becomes magnetically saturated may allow for the spool 109, when the opposing current to the other coil 115b is terminated, to at least initially move faster from the rest position then the spool 109 may have otherwise moved.

For example, referencing FIG. 7A, when the spool 109 is to be moved from the closed position to the open position, a first counter current 702 may be applied to the second coil 115b while the magnetic field of the first coil 115a becomes saturated. When the spool 109 is to be displaced, the application of the first counter current 702 to the second coil 115b may be terminated. With the magnetic field of the first coil being saturated, the spool 109 may therefore at least initially have a greater velocity than a spool 109 being displaced by the baseline waveform. Similarly, when the spool is to be return from the open position to the closed position, a second counter current 704 may be applied to the first coil 115a while the magnetic field of the second coil 115b becomes saturated. When the spool 109 is to be displaced, the application of the second counter current 704 to the first coil 115a may be terminated, thereby allowing the spool to be displaced toward the closed position. In FIG. 7A, the first and second counter currents 702, 704 may have a polarity that is opposite of that first and second peak and hold currents 502, 504, 506, 508. However, as illustrated in FIG. 7B, according to other embodiments, the first and second counter currents 702′, 704′ of the sharp-edge waveform 700′ may have a polarity that is the same as that first and second peak and hold currents 502, 504, 506, 508.

While the foregoing embodiments have illustrated particular, different waveforms for the displacement of the spool 109 between open and closed positions, and vice versa, a variety of other waveforms may be employed in addition to, or in lieu of those previously identified. Further, the number of different waveforms that may be employed by the control unit 90 may also vary.

1. A method for controlling the movement of a spool of a spool valve comprising:
determining a first engine operating condition;
selecting, by a control unit, based on the first engine operating condition, a first open current waveform;
applying the first open current waveform to at least a first coil to displace the spool from a closed position to an open position;
applying a first closed current waveform to at least a second coil to displace the spool from the open position to the closed position;
determining a second engine operating condition;
selecting, by a control unit, based on the second engine operating condition, a second open current waveform, the second open current waveform having a waveform shape different than a waveform shape of the first open current waveform; and
applying the second open current waveform to at least the first coil to displace the spool from the closed position to the open position.

2. The method of claim 1, wherein the first open waveform and the second open waveform are selected by the control unit from a group of waveforms comprising more than two different waveform shapes.

3. The method of claim 1, further including the step of assigning a current waveform to a plurality of engine operating conditions, the current waveform for each of the plurality of engine operating conditions having a different current waveform shape.

4. The method of claim 1, wherein the step of applying the first open current waveform includes applying a peak current to the first coil and a first counter current to the second coil.

5. The method of claim 4, wherein the step of applying the first closed current includes applying a peak current to the second coil and a counter current to the first coil.

6. The method of claim 1, wherein the waveform shape of the first open current waveform is similar to a waveform of the first closed current waveform.

7. The method of claim 1, wherein the waveform shape of the second open current waveform is similar to a waveform of the second closed current waveform.

8. A method for controlling the displacement of a spool of a spool valve in a fuel injector having a first coil and a second coil, the method comprising:
selecting, by the control unit, from a plurality of different current waveform shapes, a first current waveform for a first engine operating condition;
applying the first current waveform to the first coil to displace the spool from a first position to a second position;
returning the displaced spool from the second position to the first position;
selecting, by the control unit, from the plurality of different current waveform shapes a second current waveform for a second engine operating condition, the second current waveform having a waveform shape that is different than a waveform shape of the first current waveform; and
applying the second current waveform to the first coil to displace the spool from a first position to a second position.

9. The method of claim 8, further including the step of assigning a current waveform to a plurality of engine operating conditions, the current waveform for each of the plurality of engine operating conditions having a different current waveform shape.

10. The method of claim 9, wherein the step of applying the first current waveform includes applying a peak current to the first coil and a first counter current to the second coil.

11. The method of claim 9, wherein the step of returning the displaced spool to the first position includes applying a current to the second coil, the current applied to the second coil having a waveform shape similar to the waveform shape of the first current waveform.

12. A method for controlling the displacement of a spool of a spool valve in a fuel injector, the method comprising:
assigning a current waveform to each of a plurality of groups of engine operating conditions, at least a plurality of the assigned current waveforms each having a waveform shape that is different than the waveform shape of other assigned current waveforms;
detecting a first engine operating condition, the first engine operating condition being part of a first group of the plurality of groups of engine operating conditions; and
applying to at least one coil the current waveform assigned to the first group of engine operating conditions; and
displacing, by a magnetic field generated by applying the current waveform to the at least one coil, the spool of the spool valve.

13. The method of claim 12 further including the steps of:
detecting a second engine operating condition, the second engine operating condition being part of a second group of the plurality of groups of engine operating conditions; and
applying to at least one coil the current waveform assigned to the second group of engine operating conditions, the current waveform of the second group of engine operating conditions having a waveform shape that is different than a waveform shape of the current waveform assigned to the first group of engine operating conditions.

14. The method of claim 13, wherein the step of applying the current waveform includes applying a peak current to a first coil and a counter current to a second coil.

15. The method of claim 14 further including the step of terminating the counter current before displacing the spool.
